(19) United States
(12) Patent Application Publication
(10) Pub. No.: US 2014/0164318 A1
(43) Pub. Date: Jun. 12, 2014

(54) METHOD FOR DEVELOPING MULTI-TENANT APPLICATION AND DATA ACCESSING METHOD OF MULTI-TENANT APPLICATION AND SYSTEM USING THE SAME

(71) Applicant: INDUSTRIAL TECHNOLOGY RESEARCH INSTITUTE, Hsinchu (TW)

(72) Inventors: Huan-Wen Tsai, Hsinchu City (TW); Chun-Yu Wang, Taichung City (TW); Hsu-Cheng Lin, Kaohsiung City (TW); Meng-Yu Lee, Tainan City (TW)

(73) Assignee: Industrial Technology Research Institute, Hsinchu (TW)

(21) Appl. No.: 13/869,984

(22) Filed: Apr. 25, 2013

(30) Foreign Application Priority Data
Dec. 7, 2012 (TW) 101146107

(51) Int. Cl. G06F 17/30

(52) U.S. Cl. CPC G06F 17/30292
USPC 707/609

(57) ABSTRACT

A method for developing multi-tenant application, a data accessing method of multi-tenant application and a system using the same are provided. The system includes a multi-tenant application manager, a storage unit, a business schema maintainer and a data entity maintainer. The multi-tenant application manager stores a multi-tenant application. The storage unit stores a metadata table and a data storage table. The business schema maintainer generates a table schema and a data accessing interface according to a business schema. The data entity maintainer performs a table updating operation on a tenant table schema in the metadata table of the storage unit according to the table schema. In addition, the multi-tenant application performs an accessing operation on the data storage table of the storage unit through the data accessing interface and the data entity maintainer.

### CROSS-REFERENCE TO RELATED APPLICATION

This application claims the priority benefit of Taiwan application serial no. 101146107, filed on Dec. 7, 2012. The entirety of the above-mentioned patent application is hereby incorporated by reference herein and made a part of this specification.

### TECHNICAL FIELD

The disclosure relates to a development and data accessing system of multi-tenant application, a method for developing multi-tenant application and a data accessing method of multi-tenant application.

### BACKGROUND

Along with development of information technology, concepts of software as a service (SaaS) or infrastructure as a service (IaaS) have been widely used in daily life. However, regarding an online service platform or website that provides online services, there is none appropriate resources integration mechanism. For example, taking today's popular online shopping as an example, in order to construct an online shopping platform or website, it is probably required to construct its own application server and database, so as to maintain a good data accessing mechanism between the application and the database through an operation mechanism customized by the developer.

However, if each online service platform or website is constructed with its own application server and database, it is easy to cause problems of poor resource utilization efficiency and/or overburden of system resource, etc.

### SUMMARY

The disclosure is directed to a development and data accessing system of multi-tenant application, which is capable of effectively improving a development and data accessing of the multi-tenant application.

The disclosure is directed to a method for developing multi-tenant application, which is capable of effectively provide assistance in developing multi-tenant application.

The disclosure is directed to a data accessing method of multi-tenant application, which is capable of improving data accessing of the multi-tenant application. The method may perform the steps in an order different form that disclosed here.

The disclosure provides a development and data accessing system of multi-tenant application, the development and data accessing system of multi-tenant application includes a multi-tenant application manager, a storage unit, a business schema maintainer and a data entity maintainer. The multi-tenant application manager stores a multi-tenant application. The storage unit stores a metadata table and a data storage table, where the metadata table is used to store a tenant table schema, and the data storage table is used to store tenant data corresponding to the tenant table schema. The business schema maintainer is coupled to the multi-tenant application manager, and generates a table schema and a data accessing interface according a business schema. The data entity maintainer is coupled to the multi-tenant application manager, the business schema maintainer and the storage unit, and performs a table updating operation on the tenant table schema in the metadata table according to the table schema, where the multi-tenant application performs an accessing operation on the data storage table through the data accessing interface and the data entity maintainer.

The disclosure provides a method for developing multi-tenant application, which is adapted to a development and data accessing system of multi-tenant application, the development and data accessing system of multi-tenant application includes a multi-tenant application manager, a storage unit, a business schema maintainer and a data entity maintainer. The method for developing multi-tenant application includes following steps. The business schema maintainer generates a table schema and a data accessing interface corresponding to a multi-tenant application according a business schema. Then, the data entity maintainer performs a table updating operation on a tenant table schema in a metadata table of the storage unit according to the table schema. The multi-tenant application is generated according to a developing operation and the data accessing interface, and the multi-tenant application is deployed to the multi-tenant application manager.

The disclosure further provides a data accessing method of multi-tenant application, which is adapted to a development and data accessing system of multi-tenant application, the development and data accessing system of multi-tenant application includes a multi-tenant application manager, a storage unit, a business schema maintainer and a data entity maintainer, and the multi-tenant application manager stores a multi-tenant application. The data accessing method of multi-tenant application includes following steps. The multi-tenant application receives a tenant operation of a tenant, and generates a request message according to the tenant operation, and sends the request message to the data entity maintainer through a data accessing interface generated by the business schema maintainer. Moreover, the data entity maintainer performs an accessing operation on the storage unit according to the request message.

According to the above descriptions, in a developing phase of the multi-tenant application, the business schema maintainer generates the table schema and the data accessing interface corresponding to the multi-tenant application according to the business schema. Then, the data entity maintainer performs the table updating operation on the tenant table schema in the metadata table of the storage unit according to the table schema, and generates the multi-tenant application according to the developing operation and the data accessing interface. Finally, the multi-tenant application is deployed to the multi-tenant application manager.

Moreover, in the application phase of the multi-tenant application, the multi-tenant application receives the tenant operation of the tenant, and generates the request message according to the tenant operation, and sends the request message to the data entity maintainer through the data accessing interface generated by the business schema maintainer. Then, the accessing operation is performed on the storage unit according to the request message.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a framework of a development and data accessing system of multi-tenant application according to an exemplary embodiment of the disclosure.

FIG. 2 is a schematic diagram of a development and data accessing system of multi-tenant application according to an exemplary embodiment of the disclosure.

FIG. 3 is a part of program codes of a business schema according to an exemplary embodiment of the disclosure.

FIG. 4 is a part of program codes of a business schema according to another exemplary embodiment of the disclosure.

FIG. 5 is a schematic diagram of a table updating operation performed according to a business schema according to an exemplary embodiment of the disclosure.

FIG. 6 is a schematic diagram of a category structure of a data accessing interface according to an exemplary embodiment of the disclosure.

FIG. 7 is a part of program codes of a UserProfileRecord object according to an exemplary embodiment of the disclosure.

FIG. 8 is a part of program codes of a UserProfileRecord object according to another exemplary embodiment of the disclosure.

FIG. 9 is a part of sub program codes of the UserProfileRecord object according to an exemplary embodiment of the disclosure.

FIG. 10 is a part of program codes that a data accessing interface adds user data in a storage unit according to an exemplary embodiment of the disclosure.

FIG. 11 is a part of program codes that a data accessing interface adds a query condition in a data storage table of a storage unit to query a user profile table according to an exemplary embodiment of the disclosure.

FIG. 12 is a flowchart illustrating a method for developing multi-tenant application according to an exemplary embodiment of the disclosure.

FIG. 13 is a flowchart of a data accessing method of multi-tenant application according to an exemplary embodiment of the disclosure.

FIG. 14 is a flowchart of a data accessing method of multi-tenant application according to another exemplary embodiment of the disclosure.

### DETAILED DESCRIPTION OF DISCLOSED EMBODIMENTS

In order to ensure that a multi-tenant application is capable of sharing a platform resource or a system resource, an exemplary embodiment of the disclosure provides a development and data accessing system of multi-tenant application, which is capable of automatically generating a data accessing interface according to a tenant table schema submitted by a developer, such that the multi-tenant application can communicate with a data entity maintainer (DEM) through the data accessing interface to access tenant data in a database. Moreover, the DEM can also identify a tenant ID according to a tenant context object corresponding to a tenant and access data belonging to the tenant in the database. In this way, data accessing convenience of the multi-tenant application is greatly improved, and meanwhile an effect of isolating data belonging to different tenants can be achieved. Moreover, the development and data accessing system of multi-tenant application of the present exemplary embodiment can also effectively provide assistance that the developer develops or designs the multi-tenant application, and decrease a development cost.

Exemplary embodiments of the disclosure further discloses a method for developing multi-tenant application adapted to the aforementioned development and data accessing system of multi-tenant application and a data accessing method of multi-tenant application, which are described in detail with reference of figures.

A three-tier structure of a model-view-controller (MVC) is a commonly used software structure for constructing an application platform of online services. The three-tier structure of the MVC is composed of a presentation layer, a business logic layer and a data accessing layer. For example, the presentation layer provides a user interface to the user, and receives an operation instruction from the user through the user interface. Then, the business logic layer receives the operation instruction from the presentation layer, and executes a corresponding business logic operation. Finally, the data accessing layer executes a corresponding data accessing operation according to an operation result of the business logic layer.

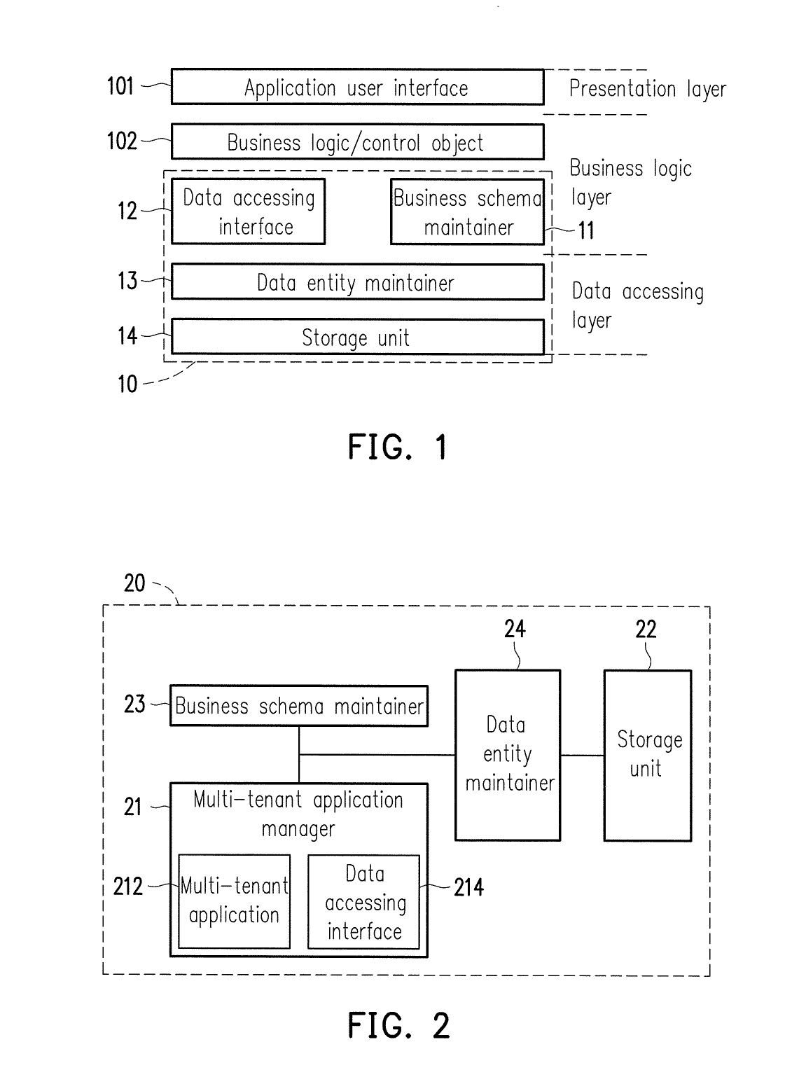

FIG. 1 is a schematic diagram of a framework of a development and data accessing system of multi-tenant application according to an exemplary embodiment of the disclosure.

Referring to FIG. 1, in view of the MVC software structure, in the present exemplary embodiment, the development and data accessing system of the multi-tenant application 10 includes a business schema maintainer (BSM) 11, a data accessing interface 12, a data entity maintainer (DEM) 13 and a storage unit 14.

The BSM 11 belongs to the business logic layer, and is used to assist the developer to develop a multi-tenant application. In detail, in a developing phase of the multi-tenant application, the BSM 11 can automatically generates the corresponding data accessing interface 12 according to a design requirement of the developer on the tenant table schema. The DEM 13 belongs to the data accessing layer, and is used to perform a data accessing operation on the storage unit 14. Particularly, the multi-tenant application can communicate with the DEM 13 through the corresponding data accessing interface 12, so as to access data (for example, tenant data belonging to the tenants) in the storage unit 14 through the DEM 13.

In the present exemplary embodiment, the development and data accessing system of the multi-tenant application 10 can simultaneously cover the business logic layer and the data accessing layer. For example, the BSM 11 and the data accessing interface 12 belong to the business logic layer, and the DEM 13 and the storage unit 14 belong to the data accessing layer. Moreover, an application user interface 101 belongs to the presentation layer, and can provide a user operation interface. A business logic/control object 102 also belongs to the business logic layer, and is used to receive an operation instruction of the user operation interface, so as to execute a corresponding logic operation according to the user operation interface. Since the application user interface 101 and the business logic/control object 102 are not essences of the disclosure, detailed descriptions thereof are omitted.

FIG. 2 is a schematic diagram of a development and data accessing system of multi-tenant application according to an exemplary embodiment of the disclosure.

Referring to FIG. 2, the development and data accessing system of the multi-tenant application 20 includes a multi-tenant application manager 21, a storage unit 22, a BSM 23 and a DEM 24.

The multi-tenant application manager 21 is used to store a multi-tenant application 212. It should be noticed that the number of the multi-tenant application 212 can be one or plural. Moreover, the multi-tenant application manager 21 can also store a general application or service, and is not limited to store the multi-tenant application. In the present exemplary embodiment, although the multi-tenant application 212 is stored in the multi-tenant application manager 21, the multi-tenant application 212 can also be executed in the multi-tenant application manager 21.

In the present exemplary embodiment, the developer can develop the multi-tenant application (for example, the multi-tenant application 212) on the development and data accessing system of the multi-tenant application 20, and deploy the developed multi-tenant application (for example, the multi-tenant application 212) in the multi-tenant application manager 21. Moreover, the developer can also directly deploy the developed multi-tenant application (for example, the multi-tenant application 212) in the multi-tenant application manager 21, which is not limited by the disclosure.

The storage unit 22 may include one or a plurality of databases and is used to store a plurality of data tables. In the present exemplary embodiment, the storage unit 22 can be a relational database management system (RDBMS), a distributed database or an object-oriented database management system (ODBMS), and can be implemented by using a standard query language (SQL) or NoSQL, etc.

In the present exemplary embodiment, the storage unit 22 stores one or a plurality of metadata tables and one or a plurality of data storage tables. The metadata table is used to store one or a plurality of tenant table schema. It should be noticed that the aforementioned tenant table schema is substantially stored in the metadata table of the storage unit 22 in a metadata format. The data storage table is used to store tenant data corresponding to the aforementioned tenant table schema. Moreover, the aforementioned tenant data is, for example, user data belongs to each tenant, etc.

For example, regarding a tenant table schema submitted by the developer, the metadata table stores navigating data or metadata of the tenant table schema, and the data storage table stores actual data of each item or field in the tenant table schema. In this way, in a data query process, the system can obtain the actual data of the corresponding item or field in the data storage table according to the navigating data or metadata in the metadata table. In other words, when tenant data of one tenant in the data storage table is used to the corresponding tenant table schema in the metadata table, a tenant profile table recording the tenant data is formed.

For example, it is assumed that a user ID field, a user name field and a user age field are defined in a tenant profile table with a tenant table name of user profile table. Now, the metadata table can be used to store metadata (i.e. the metadata of the user ID field, the user name field and the user age field) of the tenant table schema corresponding to the tenant profile table, and the data storage table is used to store a user ID (for example, 00123), a name (for example, Mary) and an age (for example, 18) of the user profile table. Then, when the user data of the user profile table is to be accessed, the system can respectively obtain the user ID (for example, 00123), the user name (for example, Mary) and the user age (for example, 18) of the user profile table from the data storage table according to the metadata corresponding to the aforementioned user ID field, the user name field and the user age field in the metadata table.

Moreover, the aforementioned tenant table schema is, for example, defined in a business schema submitted by the developer of the multi-tenant application in the developing phase. The business schema is, for example, implemented by using an extensible markup language (XML), though the disclosure is not limited thereto. In other exemplary embodiments, the business schema can also be implemented by using a standard generalized markup language (SGML), a hypertext markup language (HTML), an extensible hypertext markup language (XHTML) or a simple object access protocol (SOAP), etc.

Particularly, the data structure of the aforementioned business schema can be determined according to a design of the tenant table schema or an actual application requirement. For example, a following table 1 is a tenant table-user profile table of an exemplary embodiment of the disclosure. Referring to the table 1, it is assumed that the tenant table schema designed by the developer includes the user ID, the user name and the user age, and the above information has respective data types. Now, the above user basic data can be represented by the user profile table of the table 1.

TABLE 1

| Field | UserID | Name | Age |
|---|---|---|---|
| Data type | String | String | Integer |

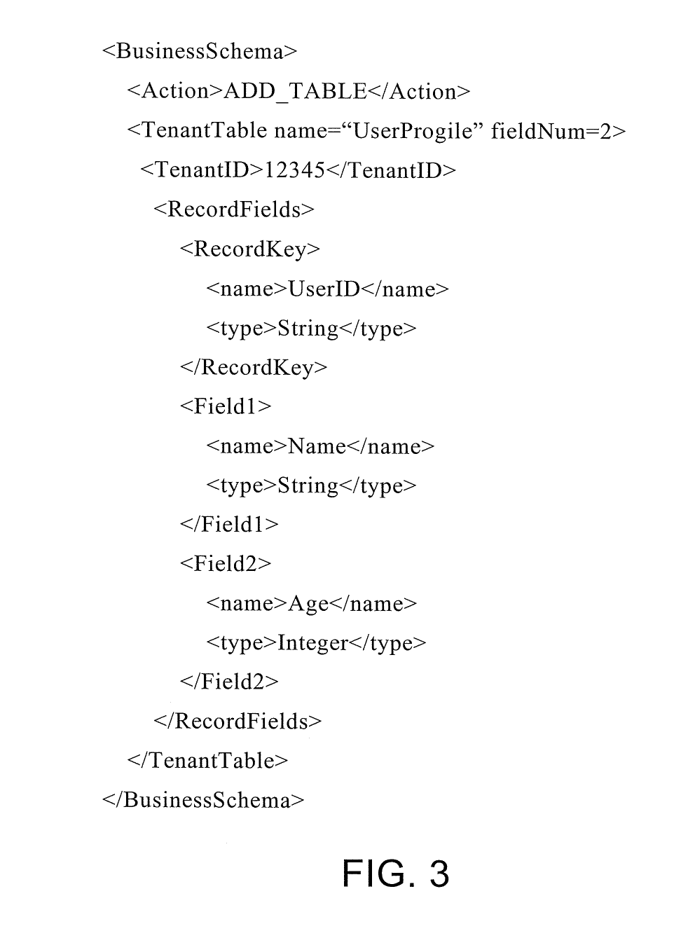

FIG. 3 is a part of program codes of a business schema according to an exemplary embodiment of the disclosure. Particularly, the business schema of FIG. 3 defines the tenant table schema of the table 1.

In detail, in the present exemplary embodiment, the business schema may include a business schema tag (for example, “<BusinessSchema>” and “</BusinessSchema>”), and the business schema tag includes a tenant table schema tag (for example, “<Tenanttable name=“UserProfile” fieldNum=2>” and “</TenantTable>”) subordinated to the business schema tag.

The tenant table schema tag (for example, “<TenantTable>” and “</TenantTable>”) is used to define various fields of the tenant table schema corresponding to the business schema. For example, the tenant table schema tag includes a tenant identification (ID) tag (for example, “<TenantID>” and “</TenantlD>”) and a record field tag (for example, “<RecordFields>” and “</RecordFields>”) subordinated to the tenant table schema tag.

The tenant ID tag is used to define a tenant ID of the tenant corresponding to the tenant table schema. For example, the business schema of FIG. 3 records the tenant table schema corresponding to the tenant with the tenant ID of “12345”.

The record field tag is used to define various record fields of the tenant table schema. For example, the record field tag may include a recordkey field tag (for example, “<RecordKey>” and </RecordKey>) and one or a plurality of non-recordkey field tag (for example, “<Field1>” and “<Field1>” and “<Field2>” and “</Field2>”) subordinated to the record field tag. The recordkey field tag and each of the non-recordkey field tags may respectively include a name tag (for example, “<name>” and “</name>”) and data type tag (for example, “<type>” and “</type>”), so as to record a name and a data type corresponding to each of the non-recordkey field.

Moreover, in view of tag attributes, the tenant table schema tag has a name attribute and a field number attribute. The name attribute is used to define a name of the tenant table schema (for example, name=“UserProfile”), and the field number attribute is used to define the number of fields in the tenant table schema excluding the recordkey field. For example, taking FIG. 3 as an example, since the non-recordkey fields in the tenant table schema tag are only “Field1” and “Field2”, the field number attribute of the tenant table schema tag is set to 2 (for example, fieldNum=2). It should be noticed that in the present exemplary embodiment, besides that the number of the recordkey field tag is fixed to 1, the number of the non-recordkey field tags can be adjusted according to an actual application or design requirement. For example, in the present exemplary embodiment, the number of the non-primary field tags can be 1 to 255, which can be represented by Field[n], where n=1-255.

In the present exemplary embodiment, the business schema tag further includes an action tag (for example, “<Action>” and “</Action>”) subordinated to the business schema tag, which defines an operation type of a table updating operation corresponding to the business schema. For example, the table updating operation may include a table adding operation (ADD_TABLE), a table querying operation (QUERY_TABLE), a table modifying operation (UPDATE_TABLE) or a table delete operation (DELETE_TABLE), which can respectively implement an adding, querying, modifying or delete operation on the tenant table schema in the metadata table in the storage unit 22. For example, taking FIG. 3 as an example, “<Action>ADD_TABLE<Action>” corresponds to the add table operation, by which the tenant table schema can be added or written into the metadata table in the storage unit 22.

Moreover, the table updating operation may further include an association adding operation (ADD_ASSOCIATION) and an association delete operation (DELETE_ASSSOCIATION). The association adding operation is used to add an association between the tenant table schema and a tenant, and the association delete operation is used to delete the association between the tenant table schema and a tenant.

Moreover, in other exemplary embodiments, the tenant table schema tag may further include a relationship tag subordinated to the tenant table schema tag to define the other tenant table schema related to the tenant table schema. The relationship tag may further include a relationship field tag, a relationship table tag and a candidate field tag subordinated to the relationship tag. The relationship field tag is used to define a relationship field of the tenant table schema. The relationship table tag is used to define a tenant table schema related to the tenant table schema. The candidate field tag is used to define a relationship field of a tenant table schema related to the tenant table schema.

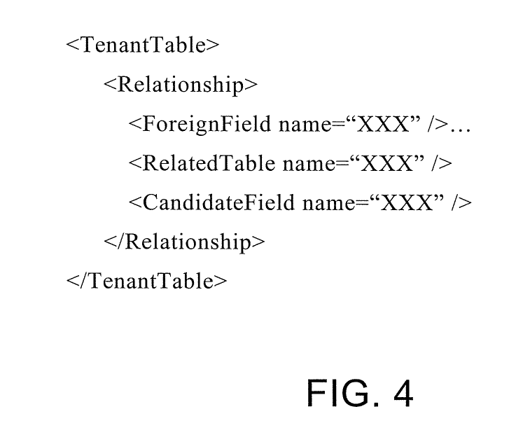

FIG. 4 is a part of program codes of a business schema according to another exemplary embodiment of the disclosure.

Referring to FIG. 4, the business schema may further include a relationship tag (for example, “<Relationship>” and “</Relationship>” and a relationship field tag (for example, “<ForeignField>” and “</ForeignField>”), a relationship table tag (for example, “<RelatedTable>” and “</RelatedTable>”) and a candidate field tag (for example, “<CandidateField>” and “</CandidateField>”) subordinated to the relationship tag.

A following table 2 discloses a mapping table of a part of tags in the business schema and function descriptions thereof according to an exemplary embodiment of the disclosure. Referring to FIG. 2, a part of tags in the business schema and function descriptions thereof are listed in detail.

TABLE 2

| Tag | Parent element | Attribute | Function description |
|---|---|---|---|
| BusinessSchema | | | Define business |
| | | | schema |
| Action | BusinessSchema | | Define operation |
| | | | action of business |
| | | | schema |
| TenantTable | BusinessSchema | name, | Define tenant table |
| | | fieldNum | schema |
| TenantID | TenantTable | | Define tenant ID |
| RecordFields | TenantTable | | Define record field |
| RecordKey | RecordFields | | Define recordkey |
| | | | field |
| name | RecordKey | | Define recordkey |
| | | | field name |
| type | RecordKey | | Define recordkey |
| | | | field type |
| Field1~Field255 | RecordFields | | Define non-recordkey |
| | | | field |
| name | Field1~Field255 | | Define non-recordkey |
| | | | field name |
| type | Field1~Field255 | | Define non-recordkey |
| | | | field name type |
| Relationship | TenantTable | name | Define relationship |
| | | | between tenant table |
| | | | schemas |
| ForeignField | Relationship | name | Define relationship |
| | | | field of tenant table |
| | | | schema |
| RelatedTable | Relationship | name | Define related tenant |
| | | | table schema |
| CandidateField | Relationship | name | Define relationship |
| | | | field of related |
| | | | tenant table schema |

However, it should be noticed that the table 1, the table 2, FIG. 3 and FIG. 4 are examples, and related implementation details thereof can be adjusted according to an actual application and design requirement.

The BSM 23 is coupled to the multi-tenant application manager 21. The BSM 23 is used to receive the business schema (which is, for example, submitted by the developer of the multi-tenant application), and generates the table schema according to the business schema.

The DEM 24 is coupled to the multi-tenant application manager 21, the storage unit 22 and the BSM 23. The DEM 24 is used to perform the aforementioned table updating operation (for example, adding, querying, modifying or delete operation, etc.) on the tenant table schema in the metadata table of the storage unit 22 according to the aforementioned table schema object.

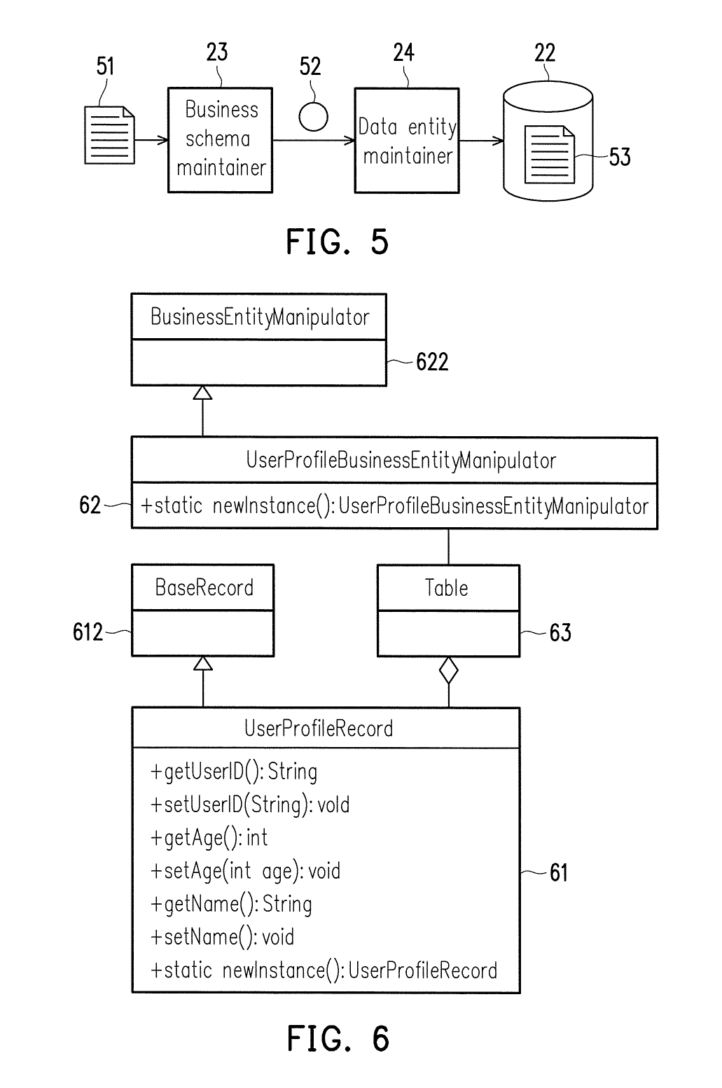

FIG. 5 is a schematic diagram of a table updating operation performed according to the business schema according to an exemplary embodiment of the disclosure.

Referring to FIG. 5, the storage unit 22, the BSM 23 and the DEM 24 of FIG. 5 are respectively the same of similar to the storage unit 22, the BSM 23 and the DEM 24 of FIG. 2, which are not repeated.

When the BSM 23 receives a business schema 51, the BSM 23 resolves the business schema 51 to extract tenant table schema information from the business schema 51. Then, the BSM 23 encapsulates the tenant table schema information into a table schema object 52. Then, the BSM 23 transmits the table schema object 52 to the DEM 24.

Finally, when the DEM 24 receives the table schema object 52, the DEM 24 starts to perform a corresponding table updating operation on a metadata table 53 in the storage unit 22.

A following table 3 is an example of the metadata table according to an embodiment of the disclosure.

TABLE 3

| Field | Data |
|---|---|
| Table ID | Tableid01 |
| Table version | 1 |
| Tenant ID | 12345 |
| Tenant table name | UserProfile |
| Table state ID | 1 |
| Creator | |
| Creating time | |
| Modifier | |
| Modifying time | |
| Recordkey field name | UserID |
| Number of record fields | 2 |
| Name of field 1 | Name |
| Name of field 2 | Age |

In order to clearly describe the table updating operation performed on the metadata table by the DEM, the business schema of FIG. 3 is taken as an example for description.

Referring to FIG. 3, FIG. 5 and the table 3, when the DEM 24 receives the table schema object 52, the DEM 24 learns that the table updating operation recorded in the business schema 51 is the “add table operation” (i.e. “<Action>ADD_TABLE<Action>” in FIG. 3) according to the table schema object 52, and writes the tenant table schema information originally defined in the business schema 51 into the metadata table 53 of the storage unit 22.

For example, according to the table schema object 52, the DEM 24 writes “13245” into the field of “tenant ID”, writes “Userprofile” into the field of “table name”, writes “UserID” into the field of “recordkey field name”, writes “2” into the field of “number of record fields”, writes “name” into the field of “name of field 1” and writes “Age” into the field of “name of field 2”. The other field data (fore example, the table ID and the table version, etc.) are, for example, automatically created by the system. However, it should be noticed that the table 3 is used as an example, which is not used to limit the disclosure. In other embodiments, the number of fields in the metadata table 53 or definitions thereof can be adjusted according to an actual application or design requirement. Moreover, the DEM 24 can also query, modify or delete the metadata of the tenant table schema in the metadata table of the storage unit 22 according to different table schema objects, which is not repeated.

It should be noticed that in the present exemplary embodiment, the BSM 23 may further automatically generate a data accessing interface 214 according to the aforementioned business schema. In the present exemplary embodiment, the data accessing interface 214 is, for example, one or a plurality of function libraries or object libraries. In this way, the multi-tenant application 212 can call functions or objects in the data accessing interface 214, and execute corresponding functions according to the functions or objects. For example, the multi-tenant application 212 can communicate with the DEM 24 through the data accessing interface 221, so as to perform data accessing operation on the storage unit 22. However, the disclosure is not limited thereto, and in an exemplary embodiment, the data accessing interface 214 can also preset in the multi-tenant application manager 21 without being obtained according to the business schema.

In the present exemplary embodiment, the BSM 23 is implemented by using a JAVA language, and a detailed generation method of the data accessing interface 214 is described below.

FIG. 6 is a schematic diagram of a category structure of a data accessing interface according to an exemplary embodiment of the disclosure.

Referring to FIG. 2 and FIG. 6, in the present exemplary embodiment, the category structure of the data accessing interface 214 is mainly composed of a UserProfileRecord object (i.e. a category object 61) and a UserProfileBusinessEntityManipulator object (i.e. a category object 62). The UserProfileRecord object (i.e. the category object 61) is inherited from a BaseRecord object (i.e. a category object 612), and each batch of tenant table schema data maps to one UserProfileRecord object. The UserProfileBusinessEntityManipulator object (i.e. the category object 62) is inherited from a BusinessEntityManipulator object (i.e. a category object 622) for providing a data accessing function. Since the disclosure does not involve the BusinessEntityManipulator object (i.e. the category object 622), description thereof is omitted.

The UserProfileRecord object (i.e. the category object 61) and the UserProfileBusinessEntityManipulator object (i.e. the category object 62) are aggregated to a table object (i.e. a category object 63). The table object (i.e. the category object 63) is similar to an execution entity of the data accessing interface 214. When the multi-tenant application 212 is to perforin an accessing operation on the storage unit 22, all of operation instructions (for example, an adding instruction, a querying instruction, a modifying instruction and a delete instruction of data) are first aggregated to the table object (i.e. the category object 63) of the data accessing interface 214 and then submitted to the DEM 24 through the UserProfileBusinessEntityManipulator object (i.e. the category object 62), and the DEM 24 performs the accessing operation on the storage unit 22.

Regarding naming of the objects, a naming rule of the UserProfileBusinessEntityManipulator object (i.e. the category object 62) is, for example, to combine the tenant table schema name (for example, UserProfile) with a suffix (for example, BusinessEntityManipulator). A naming rule of the UserProfileRecord object (i.e. the category object 61) is, for example, to combine the tenant table schema name (for example, UserProfile) with a suffix (for example, Record).

Particularly, the UserProfileRecord object (i.e. the category object 61) generates a corresponding data accessing function (for example, get function and set function) according to a definition of the tenant table schema in the business schema received by the BSM 23. A naming rule of the accessing function corresponding to each field is, for example, to add a field name to “get” or “set”. For example, taking the business schema of FIG. 3 as an example, a read function and a write function corresponding to the field of “Name” is, for example, “getName( ): String” and “setName( ): void”, and a read function and a write function corresponding to the field of “Age” is, for example, “getAge( ): int” and “setAge( ): void”.

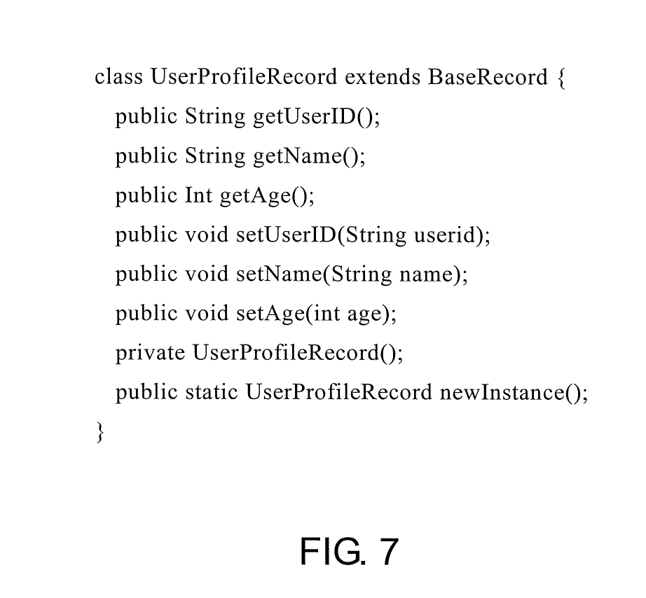

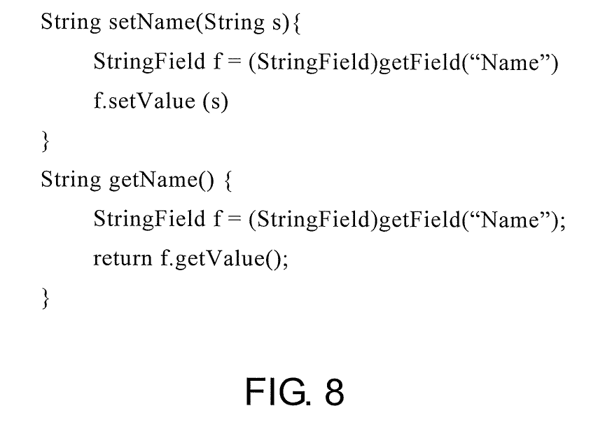

FIG. 7 is a part of program codes of the UserProfileRecord object according to an exemplary embodiment of the disclosure, and FIG. 8 is a part of program codes of the UserProfileRecord object according to another exemplary embodiment of the disclosure.

Referring to FIG. 7 and FIG. 8, FIG. 7 and FIG. 8 list the read function and the write function corresponding to the field of “Name” in the UserProfileRecord object, and a part of program codes used for generating the read function and the write function corresponding to the field of “Name”.

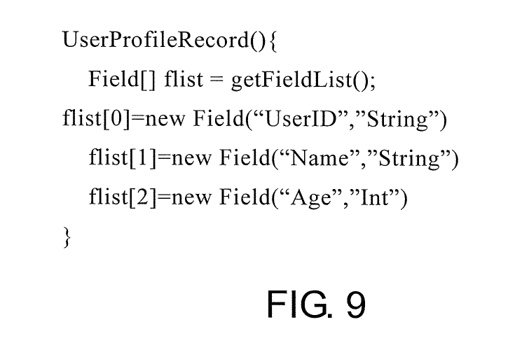

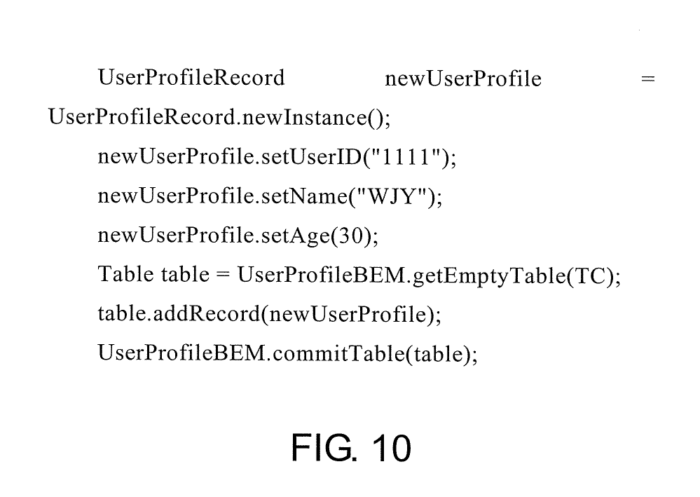

FIG. 9 is a part of sub program codes of the UserProfileRecord object according to an exemplary embodiment of the disclosure, and FIG. 10 is a part of program codes that the data accessing interface adds user data in the storage unit according to an exemplary embodiment of the disclosure.

Referring to FIG. 3 and FIG. 10, taking the business schema of FIG. 3 and the program codes of FIG. 10 as an example, after the tenant table schema defined in FIG. 3 is stored to the metadata table of the storage unit 22 in the metadata format in advance, the data accessing interface 214 can write user data with the user ID of “1111”, the user name of “WJY” and the user age of “30” into the data storage table of the storage unit 22 according to the tenant table schema pre-stored in the metadata table through the DEM 24.

Referring to FIG. 2 again, in the present exemplary embodiment, it is assumed that the multi-tenant application 212 is about to perform the accessing operation (for example, to get the tenant data) on the data storage table of the storage unit 22, first, the multi-tenant application 212 may generate a request message. For example, the multi-tenant application 212 may generate the request message according to a tenant operation of a specific tenant. Particularly, the aforementioned tenant operation can be any data read or write operation. Then, the multi-tenant application 212 can send the request message to the DEM 24 through the data accessing interface 214. Then, the DEM 24 performs tenant data accessing operation on the data storage table in the storage unit 22 according to the request message.

It should be noticed that in the present exemplary embodiment, the storage unit 22 may further include an assisting table. The assisting table include a TenantProfile table, and the TenantProfile table is used to store registration data of tenants.

In the present exemplary embodiment, the DEM 24 can obtain registration data of a tenant from the assisting table of the storage unit 22 according to ID information such as the tenant name or the tenant ID, etc. of the tenant, and generate a tenant context object according to the registration data of the tenant. For example, the multi-tenant application 212 can be connected to a uniform resource locator (URL) corresponding to the tenant to obtain ID information such as the tenant name or the tenant ID, etc. of the tenant, and transmits the ID information such as the tenant name or the tenant ID, etc. of the tenant to the DEM 24, so as to receive the tenant context object corresponding to the tenant from the DEM 24. However, the disclosure is not limited thereto. The multi-tenant application 212 may also obtain the ID information such as the tenant name or the tenant ID, etc. corresponding to each of the tenants through a table lookup method.

Then, the DEM 24 transmits back the tenant context object to the multi-tenant application 212. In this way, the multi-tenant application 212 can add the tenant context object corresponding to each tenant in the request message according to different tenants, so as to identify the tenant corresponding to each of the request messages.

For example, when a tenant performs a tenant operation (for example, a data read instruction) to the multi-tenant application 212 to access the tenant data belonging to the tenant and stored in the storage unit 22, the multi-tenant application 212 generates a request message according to the tenant operation (for example, the data read instruction). Particularly, the request message may include the aforementioned tenant context object and a request context object, where the tenant context object can be used to the identify to the tenant performing the tenant operation, and the request context object is used to present the tenant data to be obtained from or written into the database.

Then, when the DEM 24 receives the request message, the DEM 24 determines whether a data format of the request context object in the request message matches a specific tenant table schema in the metadata table of the storage unit 22, so as to avoid a problem of format incompatibility occurred when the data accessing operation is performed on the data storage table of the storage unit 22.

When the data format of the request context object in the request message matches the specific tenant table schema in the metadata table of the storage unit 22, the DEM 24 performs the accessing operation on the data storage table of the storage unit 22 according to the tenant context object and the request context object, and transmits back an execution result of the accessing operation to the data accessing interface 214. Finally, the data accessing interface 214 generates a result object according to the execution result, and transmits the result object to the multi-tenant application 212.

For example, when the above accessing operation is to obtain tenant data belonging to a tenant, the DEM 24 obtains the tenant data corresponding to the request message, and transits back the tenant data to the data accessing interface 214. Then, when the data accessing interface 214 receives the tenant data, the data accessing interface 214 converts the tenant data into a result object matches a data format of the multi-tenant application 212, and transmits the result object to the multi-tenant application 212.

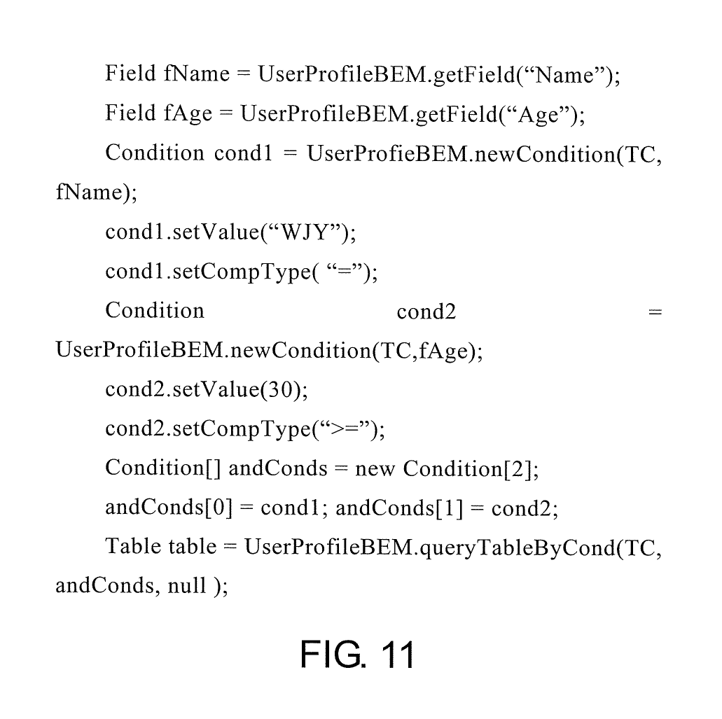

For example, FIG. 11 is a part of program codes that the data accessing interface adds a query condition in the data storage table of the storage unit to query the user profile table according to an exemplary embodiment of the disclosure.

Moreover, in the present exemplary embodiment, the assisting table of the storage unit 22 may further include a multi-tenant application table and a service level table. The multi-tenant application table is used to store information of a multi-tenant application (for example, the multi-tenant application 212), and the service level table is used to store service level information of each tenant.

For example, when the DEM 24 performs the data accessing operation on the storage unit 22 according to the request message sent by the multi-tenant application 212, the DEM 24 first queries the multi-tenant application table of the storage unit 22 to learn whether the multi-tenant application 212 is a legal or registered multi-tenant application. When the multi-tenant application 212 is the legal or registered multi-tenant application, the DEM 24 continually performs the subsequent accessing operation.

Moreover, the DEM 24 can also query the service level table of the storage unit 22 to learn an access right or service level of the tenant corresponding to the tenant context object in the request message. When the data corresponding to the request context object in the request message exceeds the access right or service level of the tenant, the DEM 24 does not performs the accessing operation, and transmits back a message of access failure to the data accessing interface 214.

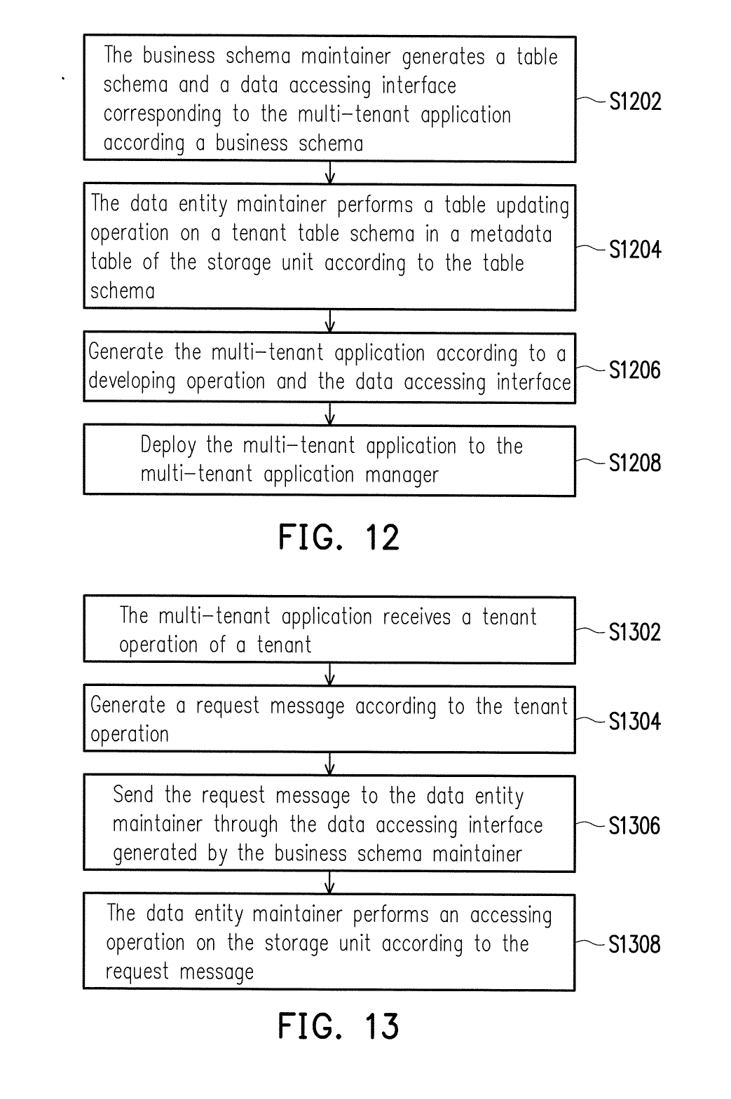

FIG. 12 is a flowchart illustrating a method for developing multi-tenant application according to an exemplary embodiment of the disclosure. The method for developing multi-tenant application of the present exemplary embodiment is adapted to the developing phase of the multi-tenant application. Moreover, development of the multi-tenant application 212 is taken as an example for descriptions.

Referring to FIG. 2 and FIG. 12, in step S1202, the BSM 23 generates a table schema and the data accessing interface 214 corresponding to the multi-tenant application 212 according a business schema. Particularly, since the aforementioned business schema is submitted by the developer of the multi-tenant application 212, the developer can design the business schema according to a user operation interface of the multi-tenant application 212 or tenant data suitable for the multi-tenant application 212.

For example, the data accessing interface 214 can be a function library or an object library, and the multi-tenant application 212 can execute a corresponding function by accessing a function or an object in the data accessing interface 214.

In step S1204, the DEM 24 performs a table updating operation on a tenant table schema in a metadata table of the storage unit 22 according to the table schema. The aforementioned table updating operation is, for example, a table adding operation, a table querying operation, a table modifying operation and/or a table delete operation, etc., which is not limited by the disclosure. In addition, Step 1202 and Step 1204 may be performed one by one or in the same time, which is not limited by the disclosure.

In step S1206, the multi-tenant application 212 is generated according to a developing operation of the developer and the data accessing interface 214. In other words, the developer can execute the developing operation on the development and data accessing system 20 of multi-tenant application to develop the multi-tenant application 212. Particularly, the developer can use the data accessing interface 214 automatically generated by the development and data accessing system 20 of multi-tenant application to develop the multi-tenant application 212, so as to greatly decrease a time required for integrating the multi-tenant application 212 and the development and data accessing system 20 of multi-tenant application.

In step S1208, the developed multi-tenant application 212 is deployed to the multi-tenant application manager 21 for the tenants or tenant users to use.

FIG. 13 is a flowchart of a data accessing method of multi-tenant application according to an exemplary embodiment of the disclosure. The data accessing method of multi-tenant application of the present exemplary embodiment is adapted to an application phase of the multi-tenant application.

Referring to FIG. 2 and FIG. 13, in step S1302, the multi-tenant application 212 receives a tenant operation of a tenant. The aforementioned tenant operation is, for example, a data read operation or a data write operation, etc., which is not limited by the disclosure.

In step S1304, the multi-tenant application 212 generates a request message according to the tenant operation.

In step S1306, the multi-tenant application 212 sends the request message to the DEM 24 through the data accessing interface 214 generated by the BSM 23 in advance.

In step S1308, the DEM 24 performs an accessing operation on the storage unit 22 according to the request message.

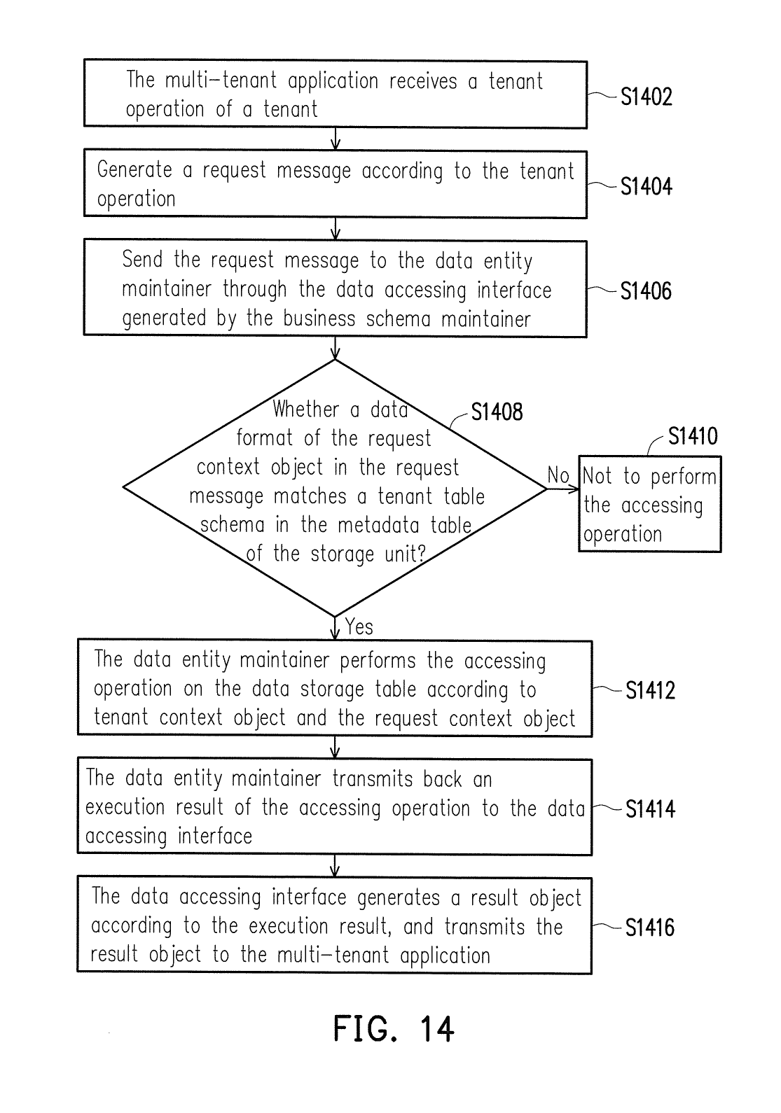

FIG. 14 is a flowchart of a data accessing method of multi-tenant application according to another exemplary embodiment of the disclosure. Similar to the data accessing method of multi-tenant application of the exemplary embodiment of FIG. 13, the present exemplary embodiment provides an implementation that the DEM 24 performs data accessing operation on the storage unit 22 according to the request message. Moreover, the data accessing method of multi-tenant application of the present exemplary embodiment is also adapted to the application phase of the multi-tenant application.

Referring to FIG. 2 and FIG. 14, in step S1402, the multi-tenant application 212 receives a tenant operation of a tenant. The aforementioned tenant operation is, for example, a data read operation or a data write operation, etc., which is not limited by the disclosure.

In step S1404, the multi-tenant application 212 generates a request message according to the tenant operation. Particularly, in the present exemplary embodiment, the request message generated by the multi-tenant application 212 may include the tenant context object and the request context object, and the identity of the tenant corresponding to the request message can be identified according to the tenant context object.

In step S1406, the multi-tenant application 212 sends the request message to the DEM 24 through the data accessing interface 214 generated by the BSM 23 in advance.

In step S1408, the DEM 24 determines whether a data format of the request context object in the request message matches a specific tenant table schema in the metadata table of the storage unit 22, and if not, in step S1410, the DEM 24 does not perform the accessing operation on the storage unit 22 to avoid the problems of read format error, etc.

If the data format of the request context object in the request message matches a specific tenant table schema in the metadata table of the storage unit 22, it represents that the data format of the request context object is the same to the data format of the tenant data stored in the storage unit 22. Therefore, in step S1412, the DEM 24 performs the accessing operation on the data storage table in the storage unit 22 according to tenant context object and the request context object in the request message. In other words, through the tenant context object in the request message, the DEM 24 can access data in the storage unit 22 according to the access right of the tenant corresponding to the tenant context object, so as to effectively isolate data belonging to different tenants.

In step S1414, the DEM 24 transmits back an execution result of the accessing operation to the data accessing interface 214.

In step S1416, the data accessing interface 214 generates a result object according to the execution result, and transmits the result object to the multi-tenant application 212.

Implementation details of various steps of the method for developing multi-tenant application of the exemplary embodiment of FIG. 12 and the data accessing methods of multi-tenant application of the exemplary embodiments of FIG. 13 and FIG. 14 can be deduced according to enough instructions and recommendations of the aforementioned embodiments, details thereof are not repeated.

It should be noticed that the aforementioned multi-tenant application manager, the storage unit, the BSM and the DEM are, for example, hardware devices composed of logic circuit components, and can be used to respectively execute the aforementioned functions. Moreover, these circuits can also be implemented by software programs or firmware programs stored in the hard disc or memory of a computer host. For example, in an embodiment, the software programs or firmware programs used for implementing the aforementioned functions are loaded into the processor of the computer host to respectively execute the aforementioned functions. Moreover, the development and data accessing system of multi-tenant application can also be operated in a distributed manner in a plurality computer host connected through a wired or wireless network.

In summary, in the development and data accessing system of multi-tenant application, the method for developing multi-tenant application and the data accessing method of multi-tenant application, in the developing phase of the multi-tenant application, the BSM generates the table schema and the data accessing interface corresponding to the multi-tenant application developed by the developer according to the business schema submitted by the developer. Then, the DEM performs the table updating operation on the tenant table schema in the metadata table of the storage unit according to the table schema, and generates the multi-tenant application according to the developing operation and the data accessing interface. Finally, the developed multi-tenant application is deployed to the multi-tenant application manager. In this way, developing efficiency of the multi-tenant application is effectively enhanced.

Moreover, in the application phase of the multi-tenant application, the multi-tenant application receives the tenant operation of the tenant, and generates the request message according to the tenant operation, and sends the request message to the DEM through the data accessing interface generated by the BSM. Then, the accessing operation is performed on the storage unit according to the request message. Particularly, in an embodiment, the aforementioned request message may include a tenant context object. In this way, according to the tenant context object, the disclosure may identify the request messages generated by tenant operations of different tenants, so as to control the accessing rights of the tenants and the multi-tenant application. Moreover, according to the disclosure, data of different tenants can be integrated and stored in a same data storage table, so as to save a memory space.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A development and data accessing system of multi-tenant application, comprising:
a multi-tenant application manager, storing a multi-tenant application;
a storage unit, storing a metadata table and a data storage table, wherein the metadata table is used to store at least one tenant table schema, and the data storage table is used to store tenant data corresponding to the at least one tenant table schema
a business schema maintainer, coupled to the multi-tenant application manager, generating a table schema and a data accessing interface corresponding to the multi-tenant application according a business schema; and
a data entity maintainer, coupled to the multi-tenant application manager, the business schema maintainer and the storage unit, and performing a table updating operation on the at least one tenant table schema in the metadata table according to the table schema,
wherein the multi-tenant application performs an accessing operation on the data storage table through the data accessing interface and the data entity maintainer.

2. The development and data accessing system of multi-tenant application as claimed in claim 1, wherein the storage unit further comprises an assisting table, the assisting table comprises a TenantProfile table, and the TenantProfile table is used to store registration data of at least one tenant,
wherein the data entity maintainer obtains registration data of a tenant from the TenantProfile table according to a tenant name of the tenant, generates a tenant context object according to the registration data of the tenant, and transmits the tenant context object to the multi-tenant application.

3. The development and data accessing system of multi-tenant application as claimed in claim 2, wherein the multi-tenant application obtains the tenant name of the tenant according to a uniform resource locator corresponding to the tenant, and transmits the tenant name of the tenant to the data entity maintainer.

4. The development and data accessing system of multi-tenant application as claimed in claim 2, wherein the assisting table further comprises a multi-tenant application table and a service level table, the multi-tenant application table is used to store information of the multi-tenant application, and the service level table is used to store service level information of the tenant.

5. The development and data accessing system of multi-tenant application as claimed in claim 1, wherein the multi-tenant application generates a request message according to a tenant operation, and sends the request message to the data entity maintainer through the data accessing interface,
wherein the data entity maintainer performs the accessing operation on the data storage table according to the request message.

6. The development and data accessing system of multi-tenant application as claimed in claim 5, wherein the request message comprises a tenant context object and a request context object,
wherein the data entity maintainer determines whether a data format of the request context object matches one of the at least one tenant table schema in the metadata table,
when the data format of the request context object matches one of the at least one tenant table schema in the metadata table, the data entity maintainer performs the accessing operation on the data storage table according to the tenant context object and the request context object, and transmits back an execution result of the accessing operation to the data accessing interface; and
the data accessing interface generates a result object according to the execution result, and transmits back the result object to the multi-tenant application.

7. The development and data accessing system of multi-tenant application as claimed in claim 1, wherein the business schema comprises a business schema tag, the business schema tag comprises an action tag and a tenant table schema tag, the action tag is used to define the table updating operation corresponding to the business schema, and the tenant table schema tag is used to define the tenant table schema of the business schema,
wherein the tenant table schema tag comprises a tenant identification tag and a record field tag, and the record field tag comprises a recordkey field tag and a non-recordkey field tag,
wherein the recordkey field tag and the non-recordkey field tag respectively comprise a name tag and a data type tag,
wherein the tenant table schema tag has a name attribute and a field number attribute.

8. The development and data accessing system of multi-tenant application as claimed in claim 7, wherein the tenant table schema tag further comprises a relationship tag, and the relationship tag comprises a relationship field tag, a relationship table tag and a candidate field tag.

9. The development and data accessing system of multi-tenant application as claimed in claim 1, wherein the table updating operation comprises a table adding operation, a table querying operation, a table modifying operation and/or a table delete operation.

10. A method for developing multi-tenant application, adapted to a development and data accessing system of multi-tenant application, wherein the development and data accessing system of multi-tenant application comprises a multi-tenant application manager, a storage unit, a business schema maintainer and a data entity maintainer, the method for developing multi-tenant application comprising:
generating a table schema and a data accessing interface corresponding to the multi-tenant application by the business schema maintainer according a business schema;
performing a table updating operation on at least one tenant table schema in a metadata table of the storage unit by the data entity maintainer according to the table schema;
generating the multi-tenant application according to a developing operation and the data accessing interface; and
deploying the multi-tenant application to the multi-tenant application manager.

11. The method for developing multi-tenant application as claimed in claim 10, wherein the business schema comprises a business schema tag, the business schema tag comprises an action tag and a tenant table schema tag, the action tag is used to define the table updating operation corresponding to the business schema, and the tenant table schema tag is used to define the tenant table schema of the business schema,
wherein the tenant table schema tag comprises a tenant identification tag and a record field tag, and the record field tag comprises a recordkey field tag and a non-recordkey field tag,
wherein the recordkey field tag and the non-recordkey field tag respectively comprise a name tag and a data type tag,
wherein the tenant table schema tag has a name attribute and a field number attribute.

12. The method for developing multi-tenant application as claimed in claim 11, wherein the tenant table schema tag further comprises a relationship tag, and the relationship tag comprises a relationship field tag, a relationship table tag and a candidate field tag.

13. The method for developing multi-tenant application as claimed in claim 10, wherein the table updating operation comprises a table adding operation, a table querying operation, a table modifying operation and/or a table delete operation.

14. A data accessing method of multi-tenant application, adapted to a development and data accessing system of multi-tenant application, the development and data accessing system of multi-tenant application comprises a multi-tenant application manager, a storage unit, a business schema maintainer and a data entity maintainer, and the multi-tenant application manager stores a multi-tenant application, the data accessing method of multi-tenant application comprising:
receiving a tenant operation of a tenant by the multi-tenant application;
generating a request message by the multi-tenant application according to the tenant operation;
sending the request message to the data entity maintainer by the multi-tenant application through a data accessing interface generated by the business schema maintainer; and
performing an accessing operation on the storage unit by the data entity maintainer according to the request message.

15. The data accessing method of multi-tenant application as claimed in claim 14, further comprising:
obtaining registration data of a tenant from a TenantProfile table of the storage unit by the data entity maintainer according to a tenant name of the tenant;
generating a tenant context object according to the registration data of the tenant; and
transmitting the tenant context object to the multi-tenant application.

16. The data accessing method of multi-tenant application as claimed in claim 15, further comprising:
obtaining the tenant name of the tenant by the multi-tenant application according to a uniform resource locator; and
transmitting the tenant name of the tenant to the data entity maintainer by the multi-tenant application.

17. The data accessing method of multi-tenant application as claimed in claim 14, wherein the request message comprises a tenant context object and a request context object, and the step of performing the accessing operation on the storage unit by the data entity maintainer according to the request message comprises:
determining whether a data format of the request context object matches one of at least one tenant table schema in a metadata table of the storage unit by the data entity maintainer;
performing the accessing operation on a data storage table by the data entity maintainer according to the tenant context object and the request context object when the data format of the request context object matches one of the at least one tenant table schema in the metadata table;
transmitting back an execution result of the accessing operation to the data accessing interface by the data entity maintainer; and
generating a result object by the data accessing interface according to the execution result, and transmitting back the result object to the multi tenant application.
